(19) United States
(12) Patent Application Publication
(10) Pub. No.: US 2022/0246137 A1
(43) Pub. Date: Aug. 4, 2022

(54) IDENTIFICATION MODEL LEARNING DEVICE, IDENTIFICATION DEVICE, IDENTIFICATION MODEL LEARNING METHOD, IDENTIFICATION METHOD, AND PROGRAM

(71) Applicant: NIPPON TELEGRAPH AND TELEPHONE CORPORATION, Tokyo (JP)

(72) Inventors: Takanori ASHIHARA, Tokyo (JP); Yusuke SHINOHARA, Tokyo (JP); Yoshikazu YAMAGUCHI, Tokyo (JP)

(73) Assignee: NIPPON TELEGRAPH AND TELEPHONE CORPORATION, Tokyo (JP)

(21) Appl. No.: 17/617,264

(22) PCT Filed: Jun. 10, 2019
(86) PCT No.: PCT/JP2019/022866

§ 371 Date: Dec. 7, 2021

(51) Int. Cl. G10L 15/06; G10L 15/16; G10L 15/22; G10L 15/02; G06N 3/08

(52) U.S. Cl. CPC G10L 15/063; G10L 15/16; G06N 3/08; G10L 15/02; G10L 15/22

(57) ABSTRACT

An identification model learning device capable of improving an identification model for a particular speech vocal sound is provided. An identification model learning device includes: an identification model learning unit configured to learn, based on learning data including a feature sequence in a frame unit of a speech and a binary label indicating whether the speech is a particular speech, an identification model including an input layer that accepts the feature sequence in the frame unit as an input and outputs an output result to an intermediate layer, one or more intermediate layers that accept an output result of the input layer or an immediately previous intermediate layer as an input and output a processing result, an integration layer that accepts an output result of a final intermediate layer as an input and outputs a processing result in a speech unit, and an output layer that outputs the label from the output of the integration layer.

### TECHNICAL FIELD

The present invention relates to an identification model learning device that learns a model used when a particular speech vocal sound (for example, a whispered vocal sound, a shouted vocal sound, or a vocal fry) is identified, and an identification device, an identification model learning method, an identification method, and a program for identifying a particular speech vocal sound.

### BACKGROUND ART

NPL 1 is a document related to a model for classifying speeches into a whispered speech or a normal speech. In NPL 1, a model that accepts a vocal sound frame as an input and outputs a posterior probability of the vocal sound frame (a probability value indicating whether the vocal sound frame is a whisper or not) is learned. When classification is performed in a speech unit in NPL 1, a module (for example, a module calculating an average value of all the posterior probabilities) is added to the latter stage of the model for use.

NPL 2 is a document related to a model for identifying a plurality of speech type (whispered/soft/normal/loud/shouted) vocal sounds.

### CITATION LIST

### Non Patent Literature

[NPL 1] “LSTM-based whisper detection”, Z. Raeesy, K. Gillespie, C. Ma, T. Drugman, J. Gu, R. Maas, A. Rastrow, B. Hoffmeister, SLT (2018)
[NPL 2] “Impact of vocal effort variability on automatic speech recognition”, P. Zelinka, M. Sigmund, J. Schimmel, Speech Communication (2012)

### SUMMARY OF THE INVENTION

### Technical Problem

In NPL 1, a non-speech section is, of course, determined to be a non-whispered vocal sound section. Therefore, even if a whispered vocal sound accounts for certain speech, it is easy to erroneously identify the whispered vocal sound as a non-whispered vocal sound depending on the length of the non-speech section.

In a model learning technology for identifying a whispered vocal sound, accuracy generally varies depending on a learning data amount. Thus, the accuracy deteriorates as the learning data amount decreases. Accordingly, the desired learning data is collected by gathering vocal sounds to be identified in a task (here, particular speech vocal sounds and non-particular speech vocal sounds relatively more than the particular speech vocal sounds) adequately and uniformly, labeling the vocal sounds, and setting the labelled vocal sounds as supervised data. In particular, particular speech vocal sounds such as whispered vocal sounds or shouted vocal sounds appear at rear intervals in a normal dialog or the like from the particular properties, and an approach is necessary, for example, by recording the particular speech vocal sounds separately. In NPL 1, particular speech vocal sound learning data (here, whispered vocal sounds) is collected in advance in order to achieve satisfactory accuracy. However, collecting the learning data in such a manner incurs considerably financial and time coasts.

Accordingly, an objective of the present invention is to provide an identification model learning device capable of improving an identification model for particular speech vocal sounds.

### Means for Solving the Problem

According to an aspect of the present invention, an identification model learning device includes: an identification model learning unit configured to learn, based on learning data including a feature sequence in a frame unit of a speech and a binary label indicating whether the speech is a particular speech, an identification model including an input layer that accepts the feature sequence in the frame unit as an input and outputs an output result to an intermediate layer, one or more intermediate layers that accept an output result of the input layer or an immediately previous intermediate layer as an input and output a processing result, an integration layer that accepts an output result of a final intermediate layer as an input and outputs a processing result in a speech unit, and an output layer that outputs the label from the output of the integration layer.

### Effects of the Invention

The identification model learning device according to the present invention can improve the identification model for particular speech vocal sounds.

### BRIEF DESCRIPTION OF DRAWINGS

FIG. 1 is a block diagram illustrating a configuration of an identification model learning device according to Example 1.

FIG. 2 is a flowchart illustrating an operation of the identification model learning device according to Example 1.

FIG. 3 is a schematic diagram illustrating an identification model of the related art.

FIG. 4 is schematic diagram illustrating an identification model according to Example 1.

FIG. 5 is a block diagram illustrating a configuration of an identification device according to Example 1.

FIG. 6 is a flowchart illustrating an operation of the identification device according to Example 1.

FIG. 7 is a block diagram illustrating a configuration of an identification model learning device according to Example 2.

FIG. 8 is a flowchart illustrating an operation of the identification model learning device according to Example 2.

FIG. 9 is a block diagram illustrating a configuration of an identification device according to Example 2.

FIG. 10 is a flowchart illustrating an operation of the identification device according to Example 2.

FIG. 11 is a block diagram illustrating a configuration of an identification model learning device according to Example 3.

FIG. 12 is a flowchart illustrating an operation of the identification model learning device according to Example 3.

FIG. 13 is a diagram illustrating results of a performance evaluation experiment of a model learned by a technology of the related art and a model learned in accordance with a method of an example.

FIG. 14 is a diagram illustrating a functional configuration example of a computer.

### DESCRIPTION OF EMBODIMENTS

Hereinafter, embodiments of the present invention will be described. The same reference numerals are given to constituent elements that have the same functions and description thereof will be omitted.

### Example 1

In Example 1, a vocal sound is assumed to be input in a speech unit in advance. Identification of the input speech is realized directly using time-series features extracted in a frame unit of the input speech, without outputting a posterior probability in each frame unit. Specifically, optimized identification is realized directly in a speech unit by inserting a layer (for example, a global max-pooling layer or the like) for integrating matrixes (or vectors) of intermediate layers output for each frame in a model such as a neural network.

As described above, it is possible to realize a statistical model for output and optimization in a speech unit rather than a statistical model for output and optimization in a vocal sound frame unit. With such a model structure, identification can be performed independently of the length or the like of a non-speech section.

[Identification Model Learning Device]

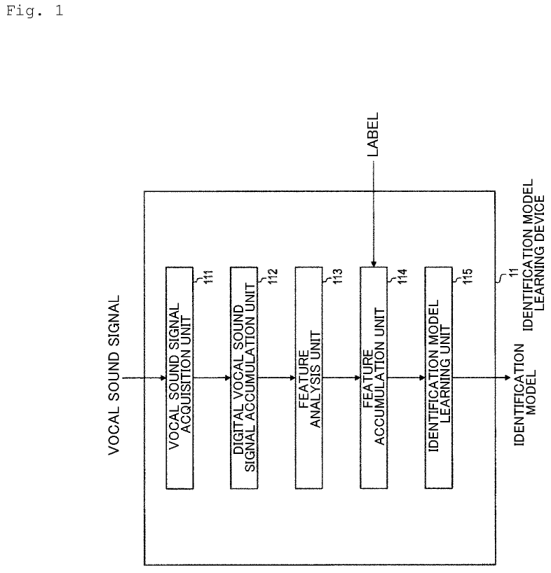

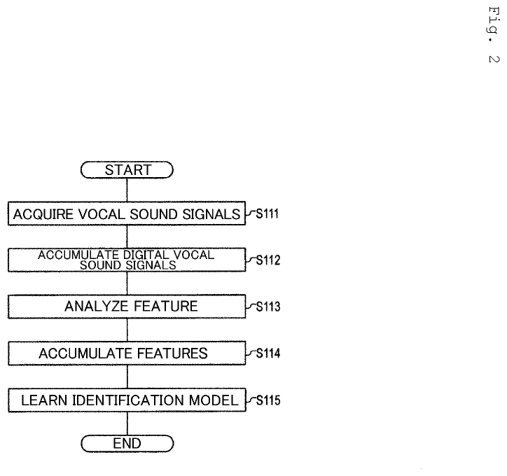

Hereinafter, a configuration of an identification model learning device according to Example 1 will be described with reference to FIG. 1. As illustrated in the drawing, an identification model learning device 11 according to this example includes a vocal sound signal acquisition unit 111, a digital vocal sound signal accumulation unit 112, a feature analysis unit 113, a feature accumulation unit 114, and an identification model learning unit 115. Hereinafter, an operation of each configuration element will be described with reference to FIG. 2.

<Vocal Sound Signal Acquisition Unit 111>

Input: vocal sound signal
Output: digital vocal sound signal
Process: AD conversion

The vocal sound signal acquisition unit 111 acquires analog vocal sound signals and converts the acquired analog vocal sound signals into digital vocal sound signals to acquire the digital vocal sound signals (S111).

<Digital Vocal Sound Signal Accumulation Unit 112>

Input: digital vocal sound signal
Output: digital vocal sound signal
Process: accumulating digital vocal sound signals

The digital vocal sound signal accumulation unit 112 accumulates the input digital vocal sound signals (S112).

<Feature Analysis Unit 113>

Input: digital vocal sound signal
Output: feature sequence for each speech
Process: analyzing feature

The feature analysis unit 113 performs acoustic sound feature extraction from the digital vocal sound signal to acquire a (acoustic) feature sequence in a frame unit for each speech (S113). As the extracted features, for example, 1 to 12-dimensional Mel-frequency Cepstrum coefficients (MFCC) based on short-time frame analysis of the vocal sound signals, dynamic parameters such as ΔMFCC. ΔΔMFCC which are dynamic features, power, Δpower, ΔΔpower, and the like are used. A Cepstrum mean normalization (CMN) process may be performed on the MFCC. The features are not limited to the MFCC or power, and parameters (for example, an autocorrelation peak values, group delay, or the like) used to identify particular speeches relatively less than non-particular speeches may be used.

<Feature Accumulation Unit 114>

Input: label, feature sequence
Output: label, feature sequence
Process: accumulating labels, feature sequences

The feature accumulation unit 114 accumulates a pair of labels (binary values) of particular speech or non-particular speech given to a speech and a feature sequence in a frame unit analyzed by the feature analysis unit 113 (S114).

<Identification Model Learning Unit 115>

Input: pair of label and feature sequence for each speech
Output: identification model
Process: learning identification model

The identification model learning unit 115 learns an identification model including an input layer, one or more intermediate layers, an integration layer, and an output layer based on a feature sequence in a frame unit of a speech and learning data including a binary label indicating whether the speech is a particular speech (S115). Here, the input layer accepts a feature sequence in a frame unit as an input and outputs an output result to an intermediate layer. The intermediate layer accepts an output result of the input layer or an immediately previous intermediate layer as an input and outputs a processing result. The integration layer accepts an output result of a final intermediate layer as an input and outputs a processing result in a speech unit. The output layer outputs a label from the output of the integration layer.

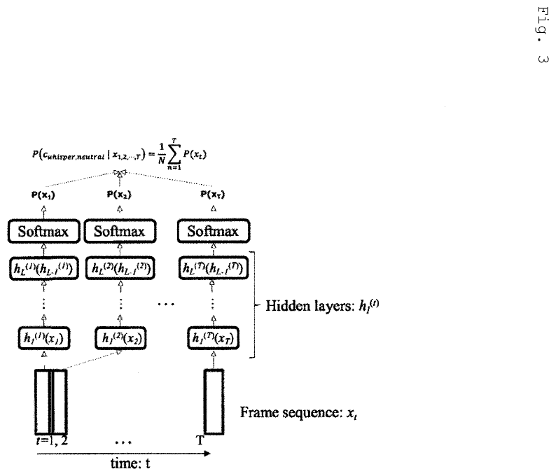

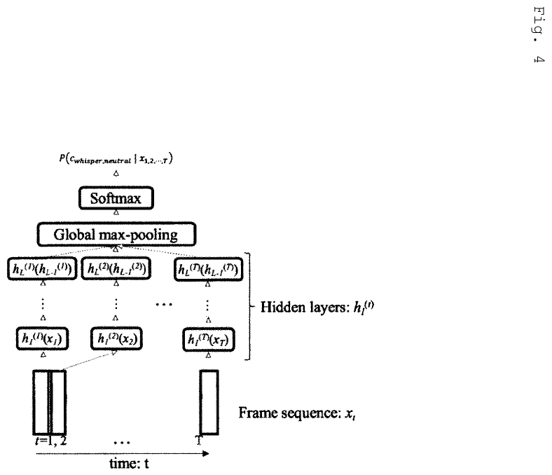

In learning of the identification model, a model such as a neural network is assumed in this example. When an identification task of a particular speech vocal sound such as a whispered vocal sound is performed in the model such as a neural network, a frame unit is input and output in the related art. In this example, however, by inserting a layer for integrating a matrix (or a vector) of an intermediate layer output to each frame (an integration layer), it is possible to realize an input in a frame unit and output in a speech unit (see FIGS. 3 and 4: FIG. 3 is a schematic diagram illustrating an identification model of the related art and FIG. 4 is a schematic diagram illustrating an identification model according to this example). The integration layer can be realized by, for example, global max-pooling or global average-pooling.

The identification model learning device 11 according to Example 1 takes the foregoing model structure and can directly optimize a speech unit. Therefore, it is possible to construct a rigid model independently of magnitude of a length of a section other than a vocal sound speech section. Because the integration layer for integrating intermediate layers is inserted and an output of the integration is directly used to determine a particular or non-particular speech unit, integral learning and estimation based on statistical modeling is possible. Compared to a technology of the related art in which there is heuristics for determining, in a speech unit, an average value or the like of posterior probabilities determined in a frame unit, accuracy is further improved to the degree of non-intervention of heuristics. When an average value in a frame unit is used, it is unclear whether a non-speech section is a particular speech section or a non-particular speech section. However, by using the foregoing scheme, it is possible to perform learning which is rarely affected by a non-speech section, a pose, or the like.

[Identification Device]

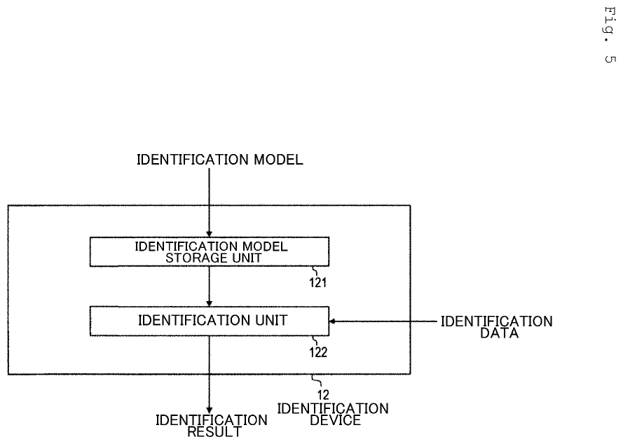

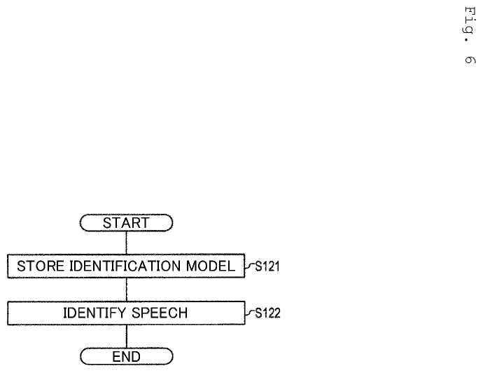

Hereinafter, a configuration of an identification device using the above-described identification model will be described with reference to FIG. 5. As illustrated in the drawing, the identification device 12 according to this example includes an identification model storage unit 121 and an identification unit 122. Hereinafter, an operation of each constituent element will be described with reference to FIG. 6.

<Identification Model Storage Unit 121>

Input: identification model
Output: identification model
Process: storing identification model

The identification model storage unit 121 stores the above-described identification model (S121). That is, the identification model storage unit 121 stores an identification model that includes an input layer, one or more intermediate layers, an integration layer, and an output layer (S121). Here, the input layer accepts a feature sequence in a frame unit of a speech as an input and outputs an output result to an intermediate layer. The intermediate layer accepts an output result of the input layer or an immediately previous intermediate layer as an input and outputs a processing result. The integration layer accepts an output result of a final intermediate layer as an input and outputs a processing result in a speech unit. The output layer outputs a binary label indicating whether the speech is a particular speech from the output of the integration layer.

<Identification Unit 122>

Input: identification model, identification data
Output: identification model, identification data
Process: identifying identification data

The identification unit 122 identifies identification data which is an arbitrary speech using the identification model stored in the identification model storage unit 121 (S122).

### Example 2

In Example 2, a situation in which learning data of a particular speech vocal sound has not an amount sufficient to learn an identification model will be assumed. In Example 2, non-particular speech vocal sounds which can be obtained easily and in bulk are all used and an identification model is learned setting the non-particular speech vocal sounds as an imbalance data condition. In general, when a class classification model is learned under the imbalance data condition and the same learning method as that of a balance data condition is applied, a model identified with a major class (a class with a large learning data amount and a non-particular speech herein) may be learned although any speech vocal sound is input. Accordingly, a learning method (for example, Reference NPL 1) in which learning can be performed correctly even under the imbalance data condition is considered to be applied.
(Reference NPL 1: “A systematic study of the class imbalance problem in convolutional neural networks”, M. Buda, A. Maki, M. A. Mazurowski, Neural Networks (2018))

In this example, a method of sampling a learning data amount in advance is considered. For example, a learning data sampling unit that performs a process of copying and increasing a data amount of a minor class (here, a particular speech) so that the data amount of the minor class is the same as the data amount of a major class (here, a non-particular speech) is included. An imbalance data learning unit that performs a process of performing learning rigidly even under the imbalance data condition (for example, a process of causing a learning cost of the minor class to be greater than a learning cost of the major class) is included.

In model learning, even in a situation in which a learning data amount is small (a particular speech vocal sound data cannot be adequately obtained), a non-particular speech vocal sound (a normal speech or the like) can be obtained easily and in bulk. Therefore, by learning the non-particular speech under the imbalance data condition, it is possible to improve accuracy of the identification model.

In general, when a model that classifies a particular speech vocal sound and a non-particular speech vocal sound is learned, an approach for collecting each vocal sound with an equal amount and learning a model is taken as in NPL 2. However, this approach has a high data collection cost as described in [Technical Problem]. On the other hand, the non-particular speech vocal sound can be obtained easily and in bulk. Therefore, by using the vocal sound data as learning data, it is possible to improve accuracy of the model even in the condition that there is only a small amount of particular speech vocal sound.

[Identification Model Learning Device]

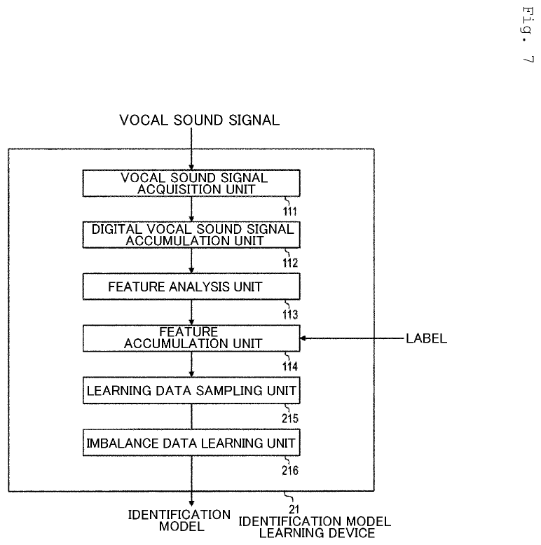

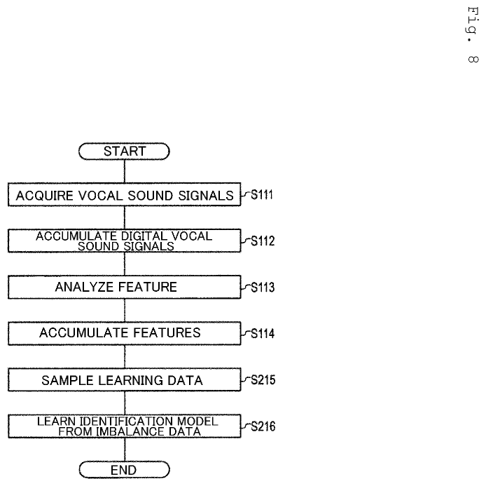

Hereinafter, a configuration of the identification model learning device according to Example 2 will be described with reference to FIG. 7. As illustrated in the drawing, an identification model learning device 21 according to this example includes a vocal sound signal acquisition unit 111, a digital vocal sound signal accumulation unit 112, a feature analysis unit 113, a feature accumulation unit 114, a learning data sampling unit 215, and an imbalance data learning unit 216. Because the vocal sound signal acquisition unit 111, the digital vocal sound signal accumulation unit 112, the feature analysis unit 113, and the feature accumulation unit 114 perform the same operations as those of Example 1, description thereof will be omitted. Hereinafter, operations of the learning data sampling unit 215 and the imbalance data learning unit 216 will be described with reference to FIG. 8.

<Learning Data Sampling Unit 215>

Input: feature sequence
Output: sampled learning data
Process: sampling feature

N₁ which is an integer equal to or greater than 1 and N₁<M<N₂ are assumed. The learning data sampling unit 215 performs sampling on a set of N₁ speeches to which a first label is given or N₂ speeches to which a second label is given and a feature sequence in a frame unit corresponding to either the speeches. Here, the speech to which the first label is given is a particular speech. The speech to which the second label indicates that the speech is a non-particular speech. The learning data sampling unit 215 outputs a set of M speeches with the first label and a set of M speeches with the second label (S215).

The learning data sampling unit 215 supplements an insufficient M−N1 non-particular speeches by sampling. As a sampling method, for example, upsampling is considered. As the upsampling method, a method of simply copying and increasing a data amount of minor class (here, a particular speech) so that the data amount of minor class is the same as a data amount of major class is considered. A similar learning method is described in Reference NPL 2.
(Reference NPL 2: “A Review of Class Imbalance Problem”, S. M. A. Elrahman, A. Abraham, Journal of Network and Innovative Computing (2013))

<Imbalance Data Learning Unit 216>

Input: sampled learning data
Output: learned identification model
Process: learning identification model

The imbalance data learning unit 216 optimizes N₂*L₁+N₁*L₂ in a learning error L₁ of a first label speech and a learning error L₂ of a second label speech using the output sets of speeches and learns the identification model (S216). Here, the identification model is an identification model that outputs the first label or the second label with regard to an input of the feature sequence in the frame unit of a speech.

In this example, because classification of two classes of particular speech vocal sounds and non-particular speech vocal sounds is possible, the identification model may be a model capable of classifying the speeches into the kinds of classes. For example, the GMM or DNN model or the like may be used as in NPL 1 or NPL 2. The learning method may be, for example, a method of optimizing a model by setting a learning error of the minor class (here, a particular speech) to L₁, setting a learning error of the major class (here, a non-particular speech) to L₂, and setting an integration value such as (L₁+L₂) as a learning error. Alternatively, as the learning method, a method of giving a weight to learning of the minor class by increasing a learning error of the minor class in accordance with the data amount like (N₂*L₁+N₁*L₂) is further appropriate. A similar learning method is described in Reference NPL 2.

For example, when extreme imbalance data is learned as it is, a model is converged as data of the minor class does not appear even once or data of the minor class appears infrequently, and learning is finished. Accordingly, by sampling a feature in the learning data sampling unit 215 (for example, the above-described upsampling), it is guaranteed that a learning data amount is adjusted and a certain amount of data of the minor class appears in learning. Further, the imbalance data learning unit 216 can perform learning efficiently and fast in accordance with, for example, the above-described method of giving a weight to the learning error L₁ of the minor class in the learning.

The identification model learning device 21 according to Example 2 can improve accuracy of the identification model by visibly utilizing the non-particular speech vocal sound data which can be obtained easily and in bulk even in a situation in which the particular speech vocal sound data cannot be adequately obtained.

[Identification Device]

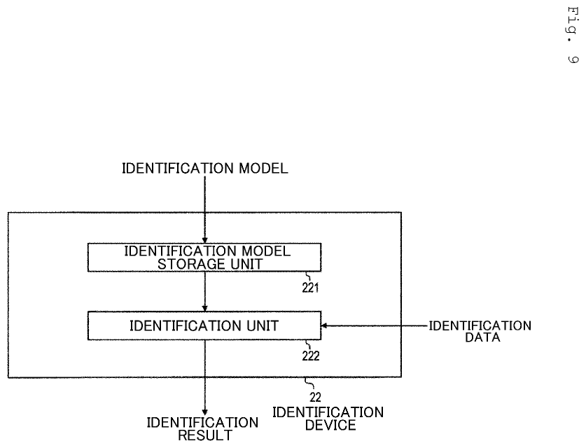

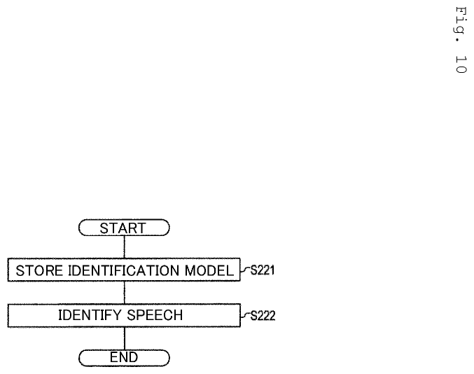

Hereinafter, a configuration of an identification device using the above-described identification model will be described with reference to FIG. 9. As illustrated in the drawing, the identification device 22 according to this example includes an identification model storage unit 221 and an identification unit 222. Hereinafter, an operation of each constituent element will be described with reference to FIG. 10.

<Identification Model Storage Unit 221>

Input: identification model
Output: identification model
Process: storing identification model

The identification model storage unit 221 stores the identification model learned by the above-described identification model learning device 21 (S221).

<Identification Unit 222>

Input: identification model, identification data
Output: identification model, identification data
Process: identifying identification data

The identification unit 222 identifies identification data which is an arbitrary speech using the identification model stored in the identification model storage unit 221 (S222).

### Example 3

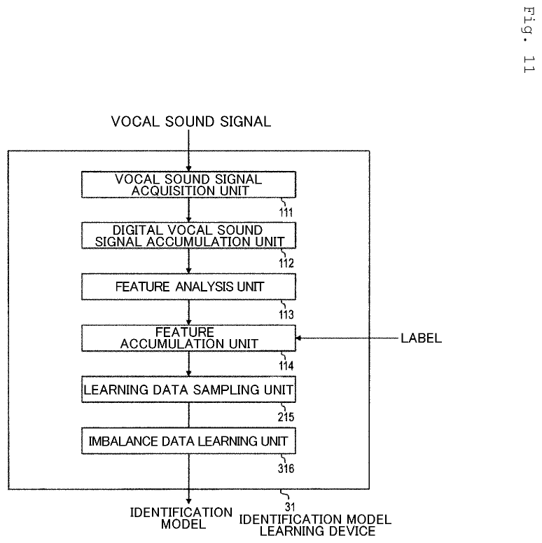

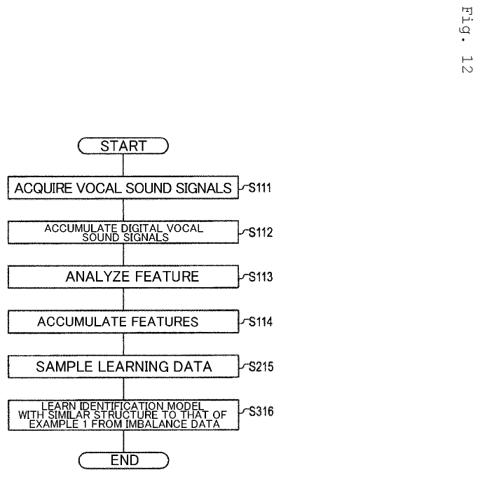

Examples 1 and 2 can be combined. That is, the structure of the identification model that outputs the identification result in the speech unit using the integration layer may be adopted as in Example 1. Further, the learning data may be sampled and the imbalance data learning may be performed as in Example 2. Hereinafter, a configuration of an identification model learning device according to Example 3 which is a combination Examples 1 and 2 will be described with reference to FIG. 11. As illustrated in the drawing, an identification model learning device 31 according to this example includes the vocal sound signal acquisition unit 111, the digital vocal sound signal accumulation unit 112, the feature analysis unit 113, the feature accumulation unit 114, the learning data sampling unit 215, and an imbalance data learning unit 316. The configurations other than the imbalance data learning unit 316 are common to those of Example 2. Hereinafter, an operation of the imbalance data learning unit 316 will be described with reference to FIG. 12.

<Imbalance Data Learning Unit 316>

Input: sampled learning data
Output: learned identification model
Process: learning identification model

The imbalance data learning unit 316 learns an identification model by optimizing N₂*L₁+N₁*L₂ in the learning error L1 of the first label speech and the learning error L2 of the second label speech using a set of output speeches with regard to an identification model that outputs the first label or the second label in the speech unit (S316). As in Example 1, the identification model for learning is an identification model that includes an input layer, one or more intermediate layers, an integration layer, and an output layer. Here, the input layer accepts a feature sequence in a frame unit of a speech as an input and outputs an output result to an intermediate layer. The intermediate layer accepts an output result of the input layer or an immediately previous intermediate layer as an input and outputs a processing result. The integration layer accepts an output result of a final intermediate layer as an input and outputs a processing result in a speech unit. The output layer outputs a binary label indicating whether the speech is a particular speech from the output of the integration layer.

<Performance Evaluation Experiment>

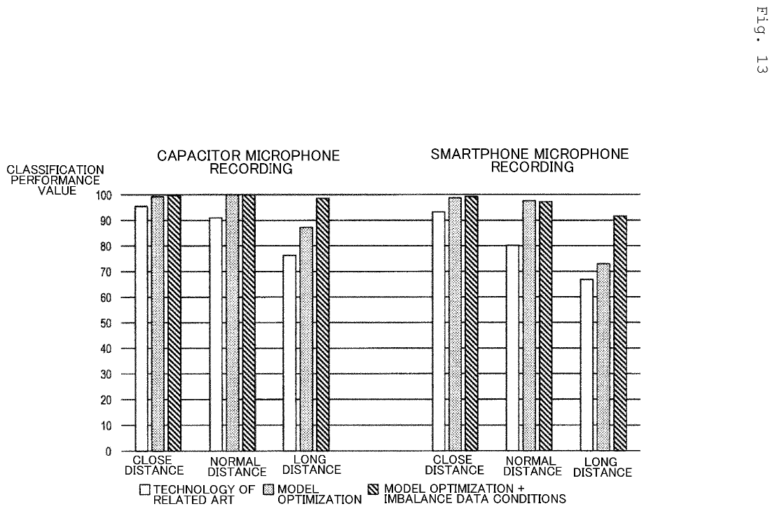

FIG. 13 is a diagram illustrating results of a performance evaluation experiment of a model learned by a technology of the related art and a model learned in accordance with an example.

In this experiment, a task for identifying two classes of “whispered vocal sound” and “normal vocal sound” was performed. A vocal sound was recorded in two patterns of a capacitor microphone recording and smartphone microphone recording. Experiment conditions of three patterns in which distances between a speaker and a microphone were a close distance=3 cm, a normal distance=15 cm, and a long distance=50 cm were prepared. Specifically, microphones were installed at the close distance, the normal distance, and the long distance and vocal sounds were recorded in juxtaposition activity. A performance evaluation result of a model learned by a technology of the related art is indicated by a white bar, a performance evaluation result of a model learned under model optimization conditions (the conditions of Example 1) is indicated by dot hatching, and a performance evaluation result of a model learned under model optimization+imbalance data conditions (the conditions of Example 3) is indicated by oblique line hatching. As illustrated in the drawing, an improvement in accuracy can be shown by optimizing the model compared to the technology of the related art. Further, a constant improvement in accuracy is acknowledged in various environments by handling data as imbalance data.

<Supplement>

The device according to the present invention includes, for example, an input unit such as a keyboard which can be connected as a single hardware entity, an output unit such as a liquid crystal display which can be connected, a communication unit to which a communication device (for example, a communication cable) that is capable of communicating with the outside of a hardware entity can be connected, a central processing unit (CPU which may include a cache storage device, register, or the like), a RAM or a ROM which is a memory, an external storage device which is a hard disk, and a bus which connects the input unit, the output unit, the communication unit, the CPU, the RAM, the ROM, and the external storage device to each other so that data can be exchanged. As necessary, the hardware entity may include a device (a drive) capable of performing reading and writing from and on a recording medium such as a CD-ROM. As a physical entity including these hardware resources, there is a general-purpose computer or the like.

The external storage device of the hardware entity stores a program necessary to realize the above-described functions and data or the like necessary for processing of the program (the present invention is not limited to the external storage device and the program may be stored in, for example, the ROM which is a reading dedicated storage device). Data obtained through the processing of the program, or the like is appropriately stored in the RAM, the external storage device, or the like.

In the hardware entity, each program stored in the external storage device (or the ROM or the like) and data necessary for processing of each program are read to a memory as necessary and are appropriately analyzed, executed, and processed by the CPU. As a result, the CPU realizes a predetermined function (each constituent element indicating the above-described units, means, and the like).

The present invention is not limited to the above-described embodiments and can be appropriately changed within the scope of the present invention without departing from the gist of the present invention. The processes described in the foregoing embodiments may be performed chronologically in the described order and may also be performed in parallel or individually in accordance with a processing performance of a device that performs the processes or as necessary.

As described above, when a processing function of the hardware entity (the device according to the present invention) described in the foregoing embodiments is realized by a computer, processing content of a function necessary for the hardware entity is described by a program. By causing the computer to execute the program, the processing function in the hardware entity is realized on the computer.

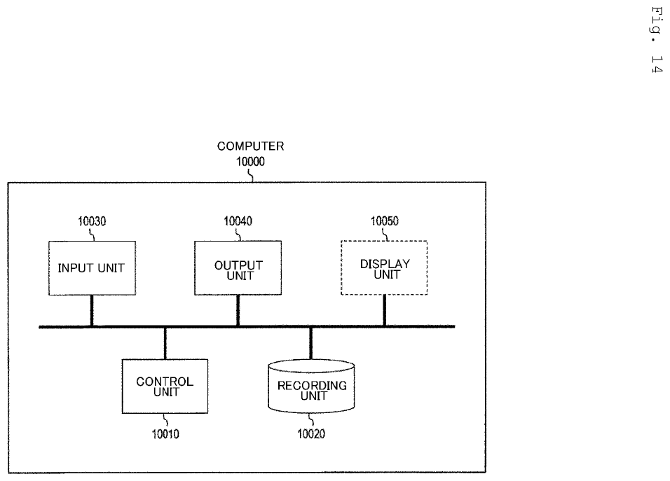

The above-described various processes are performed by causing a recording unit 10020 of a computer illustrated in FIG. 14 to read a program executing each step of the foregoing method and causing a control unit 10010, an input unit 10030, and an output unit 10040 to operate.

The program that describes the processing content can be recorded on a computer-readable recording medium. As the computer-readable recording medium, for example, any of a magnetic recording device, an optical disc, a magneto-optical recording medium, and a semiconductor memory may be used. Specifically, for example, a hard disk device, a flexible disc, a magnetic tape, or the like can be used as a magnetic recording device, a digital versatile disc (DVD), a DVD-random access memory (RAM), a compact disc read only memory (CD-ROM), a CD-recordable (R)/rewritable (RW), or the like can be used as an optical disc, a magneto-optical disc (MO) or the like can be used as a magneto-optical recoding medium, and an electronically erasable and programmable read-only memory (EEP-ROM) or the like can be used as a semiconductor memory.

The program is distributed, for example, by selling, transferring, or lending a portable recording medium such as a DVD or a CD-ROM on which the program is recorded. Further, the program may be distributed by storing the program in a storage device of a server computer and transmitting the program from the server computer to another computer via a network.

For example, a computer that executes the program first stores the program recorded on a portable recording medium or the program transmitted from the server computer temporarily in an own storage device. When the computer performs a process, the computer reads the program stored in the own recording medium and performs the process in accordance with the read program. As another execution form of the program, the computer may directly read the program from the portable recording medium and perform a process in accordance with the program. Further, whenever the program is transmitted from the server computer to the computer, the computer may perform a process in order in accordance with the received program. The above-described processes may be performed by a so-called application service provider (ASP) type service in which a processing function is realized in accordance with only an execution instruction and result acquisition without transmitting the program from the server computer to the computer. The program according to this form is assumed to include data which is equivalent to a program and is information to be provided for a process performed by a computer (data or the like which is not a direct instruction for a computer and has properties for defining a process of the computer).

In this form, the hardware entity is configured by executing a predetermined program on a computer, as described above. However, at least part of the processing content may be realized by hardware.

1. An identification model learning device including a processor configured to execute a method, comprising:
learning, based on learning data including a feature sequence in a frame of a speech and a binary label indicating whether the speech is a particular speech,
an identification model including:
an input layer accepting the feature sequence in the frame as an input and outputs an output result to an intermediate layer,
one or more intermediate layers that accept an output result of the input layer or an immediately previous intermediate layer as an input and output a processing result,
an integration layer that accepts an output result of a final intermediate layer as an input and outputs a processing result in a speech, and
an output layer that outputs the label from the output of the integration layer.

2-6. (canceled)

7. An identification model learning method performed by an identification model learning device, the method comprising:
performing sampling on a set of N₁ speeches to which a first label indicating that the speech is a particular speech is given or Na speeches to which a second label indicating that the speech is a non-particular speech is given and a feature sequence in a frame corresponding to either of the speeches when N₁<M<N₂ is assumed, and outputting a set of M speeches with the first label and a set of M speeches with the second label; and
optimizing N₂*L₁+N₁*L₂ in a learning error L₁ of a first label speech and a learning error L₂ of a second label speech using the output sets of speeches on an identification model that outputs the first label or the second label with regard to a feature sequence in a frame of a speech.

8. An identification method performed by an identification device, the method comprising:
performing sampling on a set of N₁ speeches to which a first label indicating that the speech is a particular speech is given or N₂ speeches to which a second label indicating that the speech is a non-particular speech is given and a feature sequence in a frame corresponding to either of the speeches when N₁<M<N₂ is assumed, and outputting a set of M speeches with the first label and a set of M speeches with the second label;
optimizing N₂*L₁+N₁*L₂ in a learning error L₁ of a first label speech and a learning error L₂ of a second label speech using the output sets of speeches on an identification model that outputs the first label or the second label with regard to a feature sequence in a frame of a speech; and
identifying an arbitrary speech using the learnt identification model.

9. (canceled)

10. The identification model learning device according to claim 1, wherein the particular speech includes a whispered vocal sound.

11. The identification model learning device according to claim 1, wherein the identification model includes a neural network.

12. The identification model learning device according to claim 1, wherein the identification model receives a frame as input and provides a speech as output.

13. The identification model learning method according to claim 7, wherein the particular speech includes a whispered vocal sound.

14. The identification model learning method according to claim 7, wherein the identification model includes a neural network.

15. The identification model learning method according to claim 7, wherein the identification model receives a frame as input and provides a speech as output.

16. The identification method according to claim 8, wherein the particular speech includes a whispered vocal sound.

17. The identification method according to claim 8, wherein the identification model receives a frame as input and provides a speech as output.

18. The identification method according to claim 8, wherein the particular speech includes a whispered vocal sound.
